(19) United States
(12) Patent Application Publication
(10) Pub. No.: US 2005/0134722 A1
(43) Pub. Date: Jun. 23, 2005

(54) System and method for indicating exposure information during image capture

(76) Inventor: Gregory V. Hofer, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/739,381

(22) Filed: Dec. 17, 2003

(51) Int. Cl. H04N 5/238

(52) U.S. Cl. 348/364

(57) ABSTRACT

The present invention provides a system and method for automated program updating in a remote device. Briefly described, one embodiment comprises non-destructively reading a plurality of photosensitive sites residing in a photosensor on a periodic basis, generating exposure information for each one of the non-destructive reads, and displaying the exposure information after the exposure information is generated, such that the exposure information is displayed on the periodic basis.

### TECHNICAL FIELD

The present invention is generally related to image capture devices and, more particularly, is related to a system and method for displaying exposure information during image capture.

### BACKGROUND

Images captured using extended exposure times are referred to as time-exposure images. Time-exposure images may be difficult to capture since the amount of image exposure time must be controlled to capture an image having desirable exposure qualities. For example, photographing objects of interest at night requires a relatively long exposure time in the absence of illumination provided by supplemental illumination sources, such as a flash or strobe. In other situations, such as capturing images of celestial objects, the use of supplemental illumination sources may not be desirable, and therefore require long exposure times. Furthermore, if the object of interest is not stationary, such as a moving animal, or if the object of interest is changing over time, such as a reproducing single cell organism, insufficient time may be available for the capture of the necessary plurality of time-exposure images.

To capture a time-exposure image, the user of the image capture device typically determines an initial amount of exposure time of the object of interest using an exposure meter (external or internal to the camera) or an exposure reference guide. Often, a plurality of different images of the same object are captured, each with a different exposure time. The user can later view the captured images and then select desirable images. Such a technique is time consuming since a plurality of time-exposure images must be captured. Also, capturing the plurality of time-exposure images may unnecessarily utilize limited image capture device resources, such as the digital memory used by a digital image capture device.

Another category of time-exposure images are those where there is object movement that creates an intentional blur in the image, such as fireworks or lightning streaking through the sky, or a ballerina dancing across a stage. Not only can correct exposure be difficult to judge, but also determining image content of the resulting image (determining how the image will look like while the action is being exposed) can be challenging. Many times, capturing an image having desirable image content becomes a trial and error process. Thus, a plurality of images are usually captured and later evaluated after the images are processed.

### SUMMARY

The user assistance system provides a system and method for assisting a user in operation of an image capture device. Briefly described, one embodiment is a method comprising non-destructively reading a plurality of photosensitive sites residing in a photosensor on a periodic basis, generating exposure information for each one of the non-destructive reads, and displaying the exposure information after the exposure information is generated, such that the exposure information is displayed on the periodic basis.

Another embodiment comprises a photosensor; a plurality of photosensitive sites residing in the photosensor; a processor configured to cause a plurality of non-destructive readings of the photosensitive sites on a periodic basis, and configured to determine the exposure information for each of the plurality of readings; and a display configured to display each of the determined exposure information on the periodic basis.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating an embodiment of a real-time exposure information system implemented in an image capture device.

FIGS. 2A-C are illustrative diagrams of the real-time exposure information comprising an exposure histogram and a developing thumbnail image displayed on the display of the image capture device of FIG. 1.

FIGS. 3A-C illustrative diagrams of another embodiment of the real-time exposure information comprising a developing thumbnail image or a developing full-sized image displayed on the display of the image capture device of FIG. 1.

FIGS. 4A-C are illustrative diagrams of another embodiment of the real-time exposure information comprising an exposure histogram displayed on the display of the image capture device of FIG. 1.

FIGS. 5A-C are illustrative diagrams of another embodiment of the real-time exposure information comprising a developing image and an exposure histogram displayed on the display of the image capture device of FIG. 1.

FIGS. 6A-C are illustrative diagrams of another embodiment of the real-time exposure information comprising a preview image and an exposure histogram displayed on the display of the image capture device of FIG. 1.

FIG. 7 is a flowchart illustrating an embodiment of a process for displaying exposure information during image capture.

### DETAILED DESCRIPTION

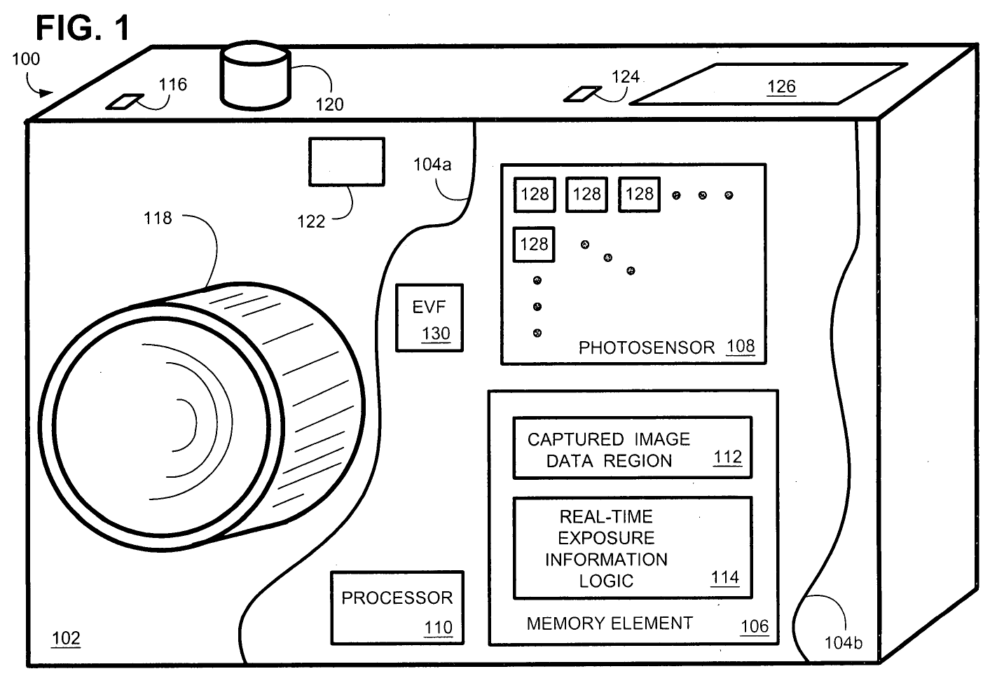

FIG. 1 is a block diagram illustrating an embodiment of a real-time exposure information system 100 implemented in an image capture device 102. As a time-exposure image is captured, real-time exposure information is displayed to the user such that the user understands exposure and/or image content of the captured image on a real-time basis. Accordingly, the user can conclude image capture based upon the viewed real-time exposure information, thereby capturing a time-exposure image having desirable exposure characteristics.

FIG. 1 includes selected external and internal components of the image capture device 102, demarked by cut-away lines 104a and 104b. Internal components, illustrated between cut-away lines 104a and 104b, include at least memory element 106, photosensor 108 and processor 110. In one embodiment, memory element 106 includes a captured image data region 112 for storing captured images and the real-time exposure information logic 114. In another embodiment, the captured image data region 112 resides in a suitable detachable memory device (not shown).

Image capture device 102 includes as external components an optional control button 116, a lens unit 118, an image capture actuation button 120, an optional viewfinder 122, a power switch 124 and a display 126. The display 126 displays real-time exposure information to the user during image capture. Display 126 is any suitable device used for previewing the target scene image prior to capturing, for viewing real-time exposure information, for viewing a menu or the like, and/or for viewing captured images. For convenience of illustration, display 126 is illustrated on the top of image capture device 102.

Operation of the image capture device 102 is initiated by actuation of the power switch 124 or an equivalent device having the same functionality. Display 126 may display a view of an image currently visible through the viewfinder 122 and/or detected by photosensor 108, referred to herein as a preview image.

Photosensor 108 comprises a matrix of light detecting photosensitive sites 128. As each of the photosensitive sites 128 are exposed to light passing through the lens unit 118, the photosensitive sites 128 collect charge or the like in proportion to the amount of light detected during the image capture exposure period. Accordingly, at the conclusion of image capture exposure period, light information from the photosensitive sites 128 can be determined such that the determined light information corresponds to the amount of light detected by each photosensitive site 128 during the image capture exposure period. This process of obtaining light information from photosensitive sites 128 is referred to hereinafter as “reading” the photosensitive sites 128.

Embodiments of the real-time exposure information system 100 are configured to collect light information (read) from all or selected ones of the photosensitive sites 128 periodically during the image capture exposure period. When the light information from a photosensitive site 128 is read, the light information is read from the photosensitive site 128 without corrupting, losing, destroying or otherwise interfering with the accumulation of charge or the like by the photosensitive site 128. Accordingly, the photosensitive site 128 is “non-destructively read” since the amount of detected light (collected charge or the like) by the photosensor site 128 is not corrupted, lost, destroyed or otherwise interfered with. That is, light information can be periodically and repeatedly read from the photosensitive site 128 in a non-destructive manner (hereinafter referred to as a “non-destructive read”) while the photo sensitive sites continue to collect charge or the like. The terms “periodic” or “periodically,” as used herein, may refer to equal time periods, unequal time periods, or varying time periods.

Prior to capturing an image, the user of the image capture device 102 may visually preview the image on display 126 or view the object to be captured through viewfinder 122. Photosensor 108 is disposed in a suitable location behind lens unit 118 such that an image of object to be captured may be focused onto photosensor 108 for capturing. When the user has focused the image and is satisfied with the focused image and image framing, the user actuates the image capture actuation button 120 (also referred to as a shutter button or a shutter release button) to cause image capture device 102 to begin image capture of the object, referred to herein as the beginning of the image capture exposure period.

At the conclusion of the image capture exposure period, light is prevented from passing through lens unit 118 so that the photosensitive sites 128 cease detecting light (cease accumulating charge or the like). Then, light information corresponding to the total amount of light detected by the photosensitive sites 128 during the image capture exposure period is communicated to processor 110. Processor 110, executing various image processing routines known in the art, then processes and saves data corresponding to the captured image into the captured image data region 112 (or in another suitable data storage medium).

In situations where the amount of light detected by the photosensitive sites 128 is large, such as during a sunny day, or when a supplemental light sources such as a flash is used during image capture, the image capture exposure period is very short. However, in other situations where the amount of light detected by the photosensitive sites 128 is relatively small, the image capture exposure period may be relatively long so that the photosensitive sites 128 detect a sufficient amount of light such that a captured image having desirable characteristics can be generated. Such situations result in the capture of a “time-exposure” image.

For example, the time required for the photosensitive sites 128 to detect a meaningful amount of light when images are captured during low ambient light conditions, such as at night without the use of a supplemental light source, may be relatively great. One such exemplary situation is capturing images of celestial objects, such as the moon, planets and/or stars. Accordingly, the real-time exposure information system 100 periodically provides the user of the image capture device 102 information corresponding to the amount of accumulated light detected by the photosensitive sites 128 during the relatively long image capture exposure period required to capture an image at night.

As another example, a time-exposure image may be desirable in relatively high ambient light conditions, such as an action shot where a blurred effect caused by object motion is desirable. One such exemplary situation is capturing an image of a dancer wherein portions of the dancer's body appear as painted brush strokes or the like in the final captured image.

As yet another example, a time-exposure image may be desirable in situations where a process is being recorded. If the process occurs only one time, such as capturing an image of a dividing living cell, it is desirable to capture an image of the process with desirable exposure quality the first time. Otherwise, the process must be repeated. If the cell of interest divides only once, it is desirable to capture an image of the dividing cell on the first attempt.

It is appreciated that the above-described situations of capturing a time-exposure image are merely illustrative of some of the situations where the user of the image capture device uses a relatively long image capture exposure period. Accordingly, embodiments of the real-time exposure information system 100 periodically and repeatedly provides exposure information to the user so that the user understands the amount of exposure of the image being captured.

In situations where a relatively short image capture exposure period is used for image capture, the real-time exposure information system 100 may be deactivated. In those situations where a relatively long image capture exposure period is used for capturing a time-exposure image, the real-time exposure information system 100 would be selectively activated. The activation of the real-time exposure information system 100 in one embodiment is controlled by the controller 116, implemented as a suitable switch, button or the like. Controller 116 may also be a multi-purpose device. In another embodiment, the real-time exposure information system 100 is controlled via a suitable graphical menu interface (GUI) selection system, or the like, that is displayed on display 126.

When the real-time exposure information system 100 is operating, all of, or selected ones of, the photosensitive sites 128 are periodically read and the current reading of the light information is communicated to processor 110. Information corresponding to the current reading of detected light information is generated (or determined) by processor 110, and then displayed on display 126. This displayed information, in its various forms, is referred to as “exposure information” herein. Furthermore, the exposure information is displayed immediately after the exposure information is generated (or as soon as possible, depending upon the processing speed or capability of the image capture device 102). In one embodiment, the exposure information corresponds to light level information that is presented in a readily understood format, such as, but not limited to, a histogram. Exposure information may also include displaying an “exposure image” that indicates image content to the user. An exposure image corresponds to the developing image of the object based upon the current reading of the photosensitive sites 208 during the image capture process.

The exposure information is displayed periodically with sufficiently short intervals between non-destructive readings such that the user can understand the progression of image exposure during the image capture exposure period. In video image capture and video display devices, it is known that the capturing and subsequent display of the video frames at a frequency of approximately twenty to thirty times per second will be perceived by a viewer as a live video. Accordingly, some embodiments of the real-time exposure information system 100 perform reads of photosensitive sites 128, and then display of the corresponding exposure information, at rates that approximate the display rate of video devices. It is appreciated that the frequency of the non-destructive reading of the photosensitive sites 128, and the display of the corresponding exposure information, may be done at any suitable frequency so long as the user perceives in a meaningful manner the on-going exposure of the image during the image capture exposure period. That is, the user is able to understand the current exposure of the object that is being captured on a “real-time” basis.

In some embodiments, the non-destructive reads of photosensitive sites 128, and the display of the corresponding exposure information, may be performed at rates that are less than the display rate of video devices. For example, the frequency may be at five displays per second in one embodiment. Even though the frequency is less than that used by video devices, the user perceives in a meaningful manner (i.e., real-time) the on-going exposure of the image during the image capture exposure period.

As described above, some embodiments of the real-time exposure information system 100 perform reads of all of the photosensitive sites 128 on a periodic basis. These embodiments provide a relatively great amount of exposure information to the user, and may allow a high-resolution captured image to be displayed to the user. That is, the user views progression of the exposure of the entire captured image (up to the resolution provided by the display 126).

In other embodiments, selected ones of the photosensitive sites 128 are non-destructively read on a periodic basis. These embodiments provide a relatively lesser amount of exposure information to the user. However, the user is able to meaningfully view progression of the exposure of the captured image. For example, one embodiment reads selected ones of the photosensitive sites 128 and displays a low-resolution image as the exposure information. Another embodiment non-destructively reads selected ones of the photosensitive sites 128 such that a thumbnail image (a reduced size image) is displayed to the user as the exposure information.

In other embodiments, all or selected ones of the photosensitive sites 128 are non-destructively read on a periodic basis and an exposure histogram is determined. The exposure histogram is displayed to the viewer as the exposure information.

An exposure histogram is generated by plotting how many times a particular exposure level (or range) occurs for the photosensitive, sites 128 that are periodically read. Different exposure values (or ranges) are plotted along the horizontal axis in increasing order. An exposure value corresponds to a value of the light information received from each non-destructive readings of the photosensor sites 128. Position of individual points on the exposure histogram (for plotted exposure values or ranges) are determined by summing the corresponding occurrences of a particular value (or range) of light information read from the photosensitive sites 128. Thus, the vertical axis corresponds to the number of pixels having the same exposure value (or within the same range of exposure values). Accordingly, as image exposure increases, the histogram is “stretched” to the right.

For convenience, the exposure histograms illustrated in the several FIGS. are shown as a single-line graph. However, it is appreciated any suitable display of the exposure information in a graphical format are the intended exposure histograms used by the various embodiments of the real-time exposure information system 100. For example, the exposure histogram may employ a plurality of bars or vertically oriented lines or the like.

The user understands progression of the exposure of the captured image by viewing the displayed exposure information. Embodiments may display the exposure information by displaying a histogram or the like (thereby indicating light level information) and/or displaying the developing exposure images (thereby indicating image content). Accordingly, embodiments of the exposure information system 100 enable the user to conclude (terminate) image capture at a time selected by the user. That is, the user selectively ends the image capture exposure period when the user is satisfied with the exposure and image content of the image being captured.

In one embodiment, the user initiates image capture (starts the image capture exposure period) by actuating the image capture actuation button 120 (also referred to as a shutter button or a shutter release button). For example, in one embodiment the user presses downward on the image capture actuation button 120. When the user is satisfied with the exposure of the captured image, the user then releases the image capture actuation button 120, thereby selectively ending image capture (ending the image capture exposure period).

In another embodiment, the user similarly initiates image capture by actuating the image capture actuation button 120, and then releases the image capture actuation button 120. When the user is satisfied with the exposure of the captured image, the user then actuates the image capture actuation button 120 a second time, thereby selectively ending image capture.

In yet another embodiment, a remote image capture actuation button (not shown) that is communicatively coupled to the image capture device 102 is actuated in one of the above-described manners. Such a remote image capture actuation button may be communicatively coupled to the image capture device 120 using any suitable means, such as, but not limited to, a wire connection, an infrared medium, a radio frequency (RF) media, a sonic based media, a microwave media, or the like.

It is appreciated that any suitable means for initiating image capture (starting the image capture exposure period) and terminating image capture (ending the image capture exposure period) may be employed by embodiments of the real-time exposure information system 100.

As described above, embodiments of the real-time exposure information system 100 perform reads of photosensitive sites 128, and displays the corresponding exposure information, at rates such that the user is able to understand the current exposure of the object that is being captured. That is, the user views displayed exposure information on a “real-time” basis. Exemplary embodiments of exposure information are described below.

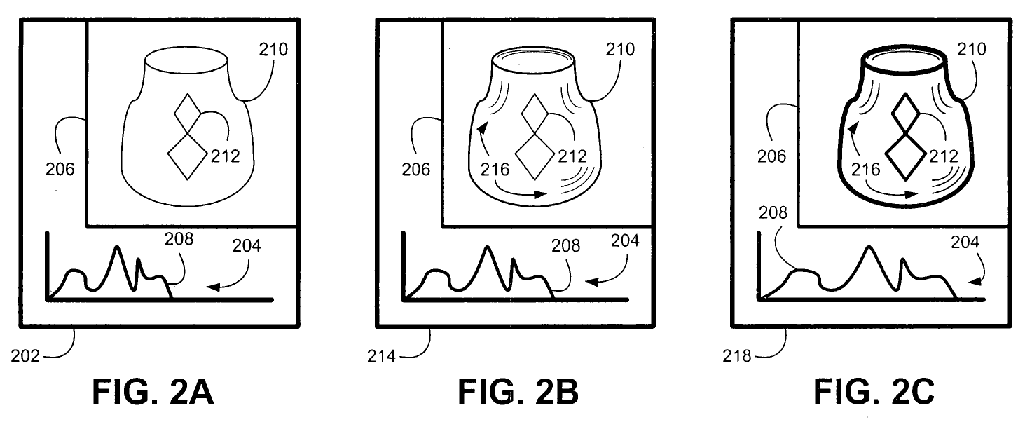

FIGS. 2A-C are illustrative diagrams of the real-time exposure information comprising an exposure histogram 204 and an exposure image 206 displayed on the display 126 ( FIG. 1). In this exemplary embodiment, the developing exposure image 206 is referred to as a developing thumbnail image for convenience. The developing thumbnail image is a reduced-size, lower-resolution image that indicates image content to the user.

FIG. 2A is a view 202 displaying an exposure histogram 204 and a developing thumbnail image 206 on display 126 such that the user viewing the view 202 understands that the photosensitive sites 128 (FIG. 1) have received relatively little exposure based upon that particular non-destructive reading. The exposure histogram 204 comprises a graph 208 indicating the exposure of the photosensitive sites 128. Graph 208 indicates that the photosensitive sites 128 have detected a relatively small amount of light since the graph 208 is closer to the left-hand side of the exposure histogram 204. The developing thumbnail image 206 shows the current image of the object of interest, ajar 210 having a design 212 thereon. Developing thumbnail image 206 indicates to the user that the photosensitive sites 128 have detected a relatively small amount of light since the jar 210 is barely discernable in the thumbnail image 206.

FIG. 2B is a view 214 displaying another exposure histogram 204 and another developing thumbnail image 206 on display 126, based upon a non-destructive reading of the photosensitive sites 128 taken at a later time than the non-destructive reading used to generate view 202. Accordingly, the user viewing the view 214 understands that the photosensitive sites 128 (FIG. 1) have received relatively more exposure. Graph 208 indicates that the photosensitive sites 128 have detected relatively more light since the graph 208 has extended further to the right of the exposure histogram 204. Developing thumbnail image 206 now indicates that the photosensitive sites 128 have detected relatively more light since the jar 210 is more discernable in the thumbnail image 206. Details 216 of the jar 210 are now becoming visible.

FIG. 2C is a view 218 displaying another exposure histogram 204 and another developing thumbnail image 206 on display 126 based upon a non-destructive reading of the photosensitive sites 128 taken at a later time than the non-destructive reading used to generate view 214. Accordingly, the user viewing the view 218 understands that the photosensitive sites 128 (FIG. 1) have received even more exposure. Graph 208 indicates that the photosensitive sites 128 have detected relatively more light since the graph 208 has extended almost fully to the right-hand side of the exposure histogram 204. Developing thumbnail image 206 now indicates that the photosensitive sites 128 have detected relatively more light since the jar 210, design 212 and details 216 are clearly discernable in the developing thumbnail image 206.

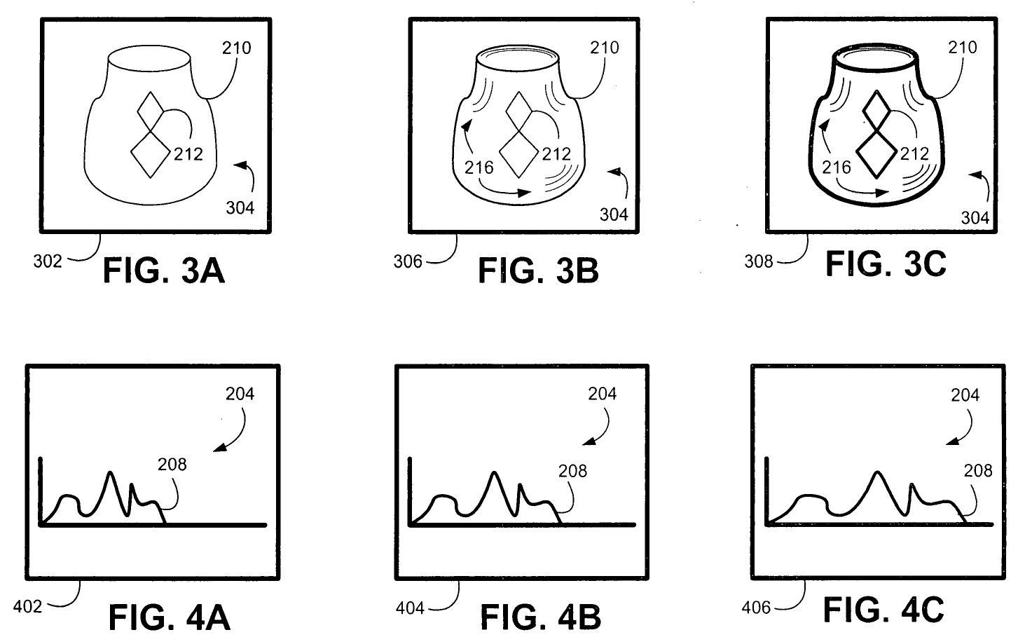

In this simplified example illustrating three of a series of displayed exposure information (exposure histograms 204 to illustrate light level information and developing thumbnail images 206 to illustrate image content), it is assumed that the user is satisfied with the exposure shown in view 218, and that the user then selectively ends image capture (ends the image capture exposure period). It is understood that only three of a plurality of time-sequenced exposure information displays are illustrated in FIGS. 2A-2C (and also with FIGS. 3A-C, 4A-C, 5A-C and 6A-C described below), and that the user would be viewing in real time a sequential plurality of periodic exposure information as exposure of the captured image progresses.

FIGS. 3A-C are illustrative diagrams of another embodiment of the real-time exposure information comprising a developing exposure image. The exposure image may be displayed as a developing thumbnail image or a developing full-sized image on the display 126 (FIG. 1). In one embodiment, the developing thumbnail image or a low-resolution image may be displayed on a portion of the display 126, convenient when only selected photosensitive sites 128 are read. In another embodiment, a developing full-sized, higher-resolution image is displayed on display 126.

FIG. 3A is a view 302 displaying a developing exposure image 304 of the object of interest, a jar 210 having a design 212 thereon. View 302 indicates that the photosensitive sites 128 have detected a relatively small amount of light since the jar 210 is barely discemable in the view 302. FIG. 3B is a view 306 based upon another non-destructive reading of the photosensitive sites 128 taken at a later time than the non-destructive reading used to generate view 302. Accordingly, the user viewing view 306 understands that the photosensitive sites 128 (FIG. 1) have detected relatively more light since the developing exposure image 304 of the jar 210 and details 216 are more discernable in the view 306. FIG. 3C is a view 308 based upon another non-destructive reading of the photosensitive sites 128 taken at a later time that the non-destructive reading used to generate view 304. Accordingly, the user viewing the view 308 understands that the photosensitive sites 128 (FIG. 1) have detected relatively more light since developing exposure image 304 of the jar 210 and details 216 are clearly discernable in the view 306.

FIGS. 4A-C are illustrative diagrams of another embodiment of the real-time exposure information comprising an exposure histogram displayed on the display 126 (FIG. 1). FIG. 4A is a view 402 displaying an exposure histogram. In this embodiment, a developing thumbnail image, a low-resolution developing exposure image or a high-resolution developing exposure image, is not displayed. View 402 indicates that the photosensitive sites 128 have detected a relatively small amount of light since the graph 208 is closer to the left-hand side of the exposure histogram 204 in the view 402. FIG. 4B is another view 404 based upon a non-destructive reading of the photosensitive sites 128 taken at a later time than the non-destructive reading used to generate view 402. Accordingly, the user viewing view 404 understands that the photosensitive sites 128 (FIG. 1) have detected relatively more light since the graph 208 has extended further to the right of the exposure histogram 204 in the view 404. FIG. 4C is yet another view 406 based upon a non-destructive reading of the photosensitive sites 128 taken at a later time that the non-destructive reading used to generate view 404. Accordingly, the user viewing the view 406 understands that the photosensitive sites 128 (FIG. 1) have detected relatively more light since the graph 208 has extended almost fully to the right-hand side of the exposure histogram 204 in the view 406.

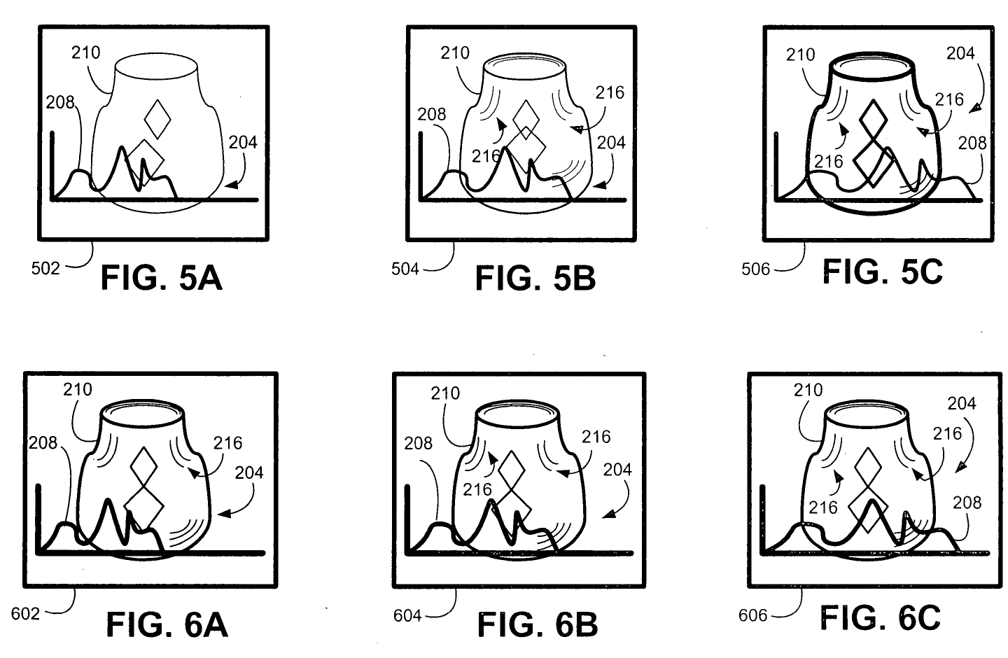

FIGS. 5A-C are illustrative diagrams of another embodiment of the real-time exposure information comprising a developing full-sized image and an exposure histogram displayed on the display 126 (FIG. 1). Here, the exposure histogram 204 is displayed over, superimposed on, or overlaid on the full-sized developing exposure image of the jar 210. Accordingly, the user viewing the view 502 (FIG. 5A) understands that the photosensitive sites 128 have received relatively little exposure since the graph 208 is closer to the left-hand side of the exposure histogram 204 and since the developing exposure image of the jar 210 is barely discernable. The user viewing the view 504 (FIG. 5B) understands that the photosensitive sites 128 have received relatively more exposure since the graph 208 has extended further to the right of the exposure histogram 204 and since details 216 of the jar 210 are now becoming visible. The user viewing the view 504 (FIG. 5C) understands that the photosensitive sites 128 have received even more exposure since the graph 208 has extended almost fully to the right-hand side of the exposure histogram 204 and since the developing exposure image of the jar 210 is clearly discernible.

FIGS. 6A-C are illustrative diagrams of another embodiment of the real-time exposure information comprising a preview image and an exposure histogram displayed on the display 126 (FIG. 1). Here, the exposure histogram 204 is displayed over, superimposed on, or overlaid on a preview image of the jar 210. The preview image of the jar does not significantly change through the series of displayed exposure histograms 204. View 602 (FIG. 6A) indicates that the photosensitive sites 128 have detected a relatively small amount of light since the graph 208 is closer to the left-hand side of the exposure histogram 204 in the view 602. View 604 (FIG. 6B) is based upon another non-destructive reading of the photosensitive sites 128 taken at a later time than the reading used to generate view 602. Accordingly, the user viewing view 604 understands that the photosensitive sites 128 (FIG. 1) have detected relatively more light since the graph 208 has extended further to the right of the exposure histogram 204. View 606 (FIG. 6C) is based upon another non-destructive reading of the photosensitive sites 128 taken at a later time that the reading used to generate view 604. Accordingly, the user viewing the view 606 understands that the photosensitive sites 128 (FIG. 1) have detected relatively more light since the graph 208 has extended almost fully to the right-hand side of the exposure histogram 204.

In yet another embodiment, the exposure information is displayed in the view of an electronic viewfinder 130 (EVF), viewable through viewfinder 122 (FIG. 1). In one such embodiment, the exposure histogram is displayed concurrently with a preview image, similar to the illustrations of FIGS. 6A-6B. In another embodiment, the exposure histogram is displayed concurrently with a developing exposure image, similar to the illustrations of FIGS. 5A-5B. In yet another embodiment, the exposure histogram is displayed over the view coming through the optics of the viewfinder 122 using a ‘heads up’ display format. In yet another embodiment, a developing image (with or without an exposure histogram) is displayed on EVF 130. It is appreciated that other embodiments displaying various types of exposure information using an electronic viewfinder 130 may be implemented similar to any of the embodiments displaying exposure information on display 126.

Other types of exposure information may include indicia that corresponds to exposure of the captured image, wherein the indicia can be displayed on a “real-time” basis herein. Such indicia are determined based upon periodic non-destructive readings of the photosensor sites 128 during taken during the image capture exposure period. Non-limiting examples of such indicia include bar or pie chart animations, clock-like animations, or other graphical animations.

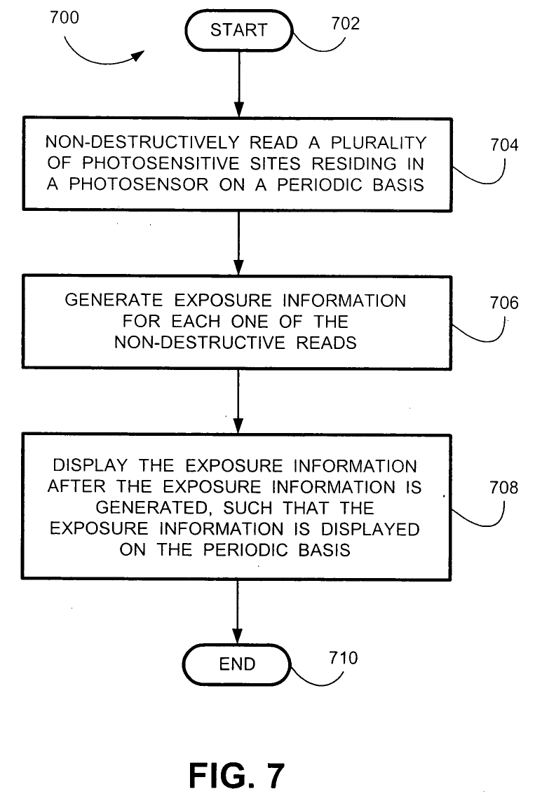

FIG. 7 shows a flow chart 700, according to the various embodiments of real-time exposure information system 100 (FIG. 1). The flow chart 700 shows the architecture, functionality, and operation of one possible embodiment for implementing the real-time exposure information logic 114 (FIG. 1) such that light information from non-destructive reads of photosensor sites 128 is used to generate exposure information (exposure histograms and/or developing images), as described above in accordance with the present invention. An alternative embodiment implements the logic of flow chart 700 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 7, or may include additional functions. For example, two blocks shown in succession in FIG. 7 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention

The process begins at block 702. At block 704, a plurality of photosensitive sites residing in a photosensor on a periodic basis are non-destructively read. At block 706, exposure information for each one of the non-destructive reads is generated. At block 708, the exposure information is displayed after the exposure information is generated, such that the exposure information is displayed on the periodic basis. The process ends at block 710.

Embodiments of the invention implemented in memory element 106 (FIG. 1) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of implementations. Many variations and modifications may be made to the above-described embodiments. All such modifications and variations are intended to be included herein within the scope of this disclosure and protected by the following claims.

1. A system which indicates exposure information during image capture comprising:
a photosensor;
a plurality of photosensitive sites residing in the photosensor;
a processor configured to cause a plurality of non-destructive readings of the photosensitive sites on a periodic basis, and configured to determine the exposure information for each of the plurality of non-destructive readings; and
a display configured to display each of the determined exposure information on the periodic basis.

2. The system of claim 1, wherein the exposure information further comprises a plurality of exposure histograms, each of the exposure histograms uniquely corresponding to one of the plurality of non-destructive readings of the photosensitive sites and displayed on the display.

3. The system of claim 1, wherein the exposure information further comprises a plurality of exposure images, each of the exposure images uniquely corresponding to one of the plurality of non-destructive readings of the photosensitive sites and displayed on the display.

4. The system of claim 3, wherein the exposure images further comprise thumbnail images.

5. The system of claim 3, wherein the exposure images further comprise full-sized high-resolution images.

6. The system of claim 3, wherein the exposure images further comprise low-resolution images.

7. The system of claim 1, wherein the exposure information further comprises:
a plurality of exposure histograms, each of the exposure histograms uniquely corresponding to one of the plurality of non-destructive readings of the photosensitive sites and displayed on the display; and
a plurality of exposure images, each of the exposure images uniquely corresponding to one of the plurality of non-destructive readings of the photosensitive sites and displayed on the display.

8. The system of claim 1, further comprising means to activate the system when time-exposure images are captured and to deactivate the system when other images are captured.

9. The system of claim 1, further comprising:
means to initiate image capture wherein an image capture exposure period is started; and
means to terminate image capture wherein the image capture exposure period is ended.

10. A method for indicating exposure information during image capture, the method comprising the steps of:
non-destructively reading a plurality of photosensitive sites residing in a photosensor on a periodic basis;
generating an exposure information for each one of the non-destructive reads; and
displaying the exposure information after the exposure information is generated, such that the exposure information is displayed on the periodic basis.

11. The method of claim 10, further comprising the steps of:
initiating an image capture exposure period such that the step of non-destructively reading begins; and
terminating the image capture exposure period such that the step of non-destructively reading ends.

12. The method of claim 10, further comprising the steps of:
actuating a controller such that the steps of non-destructively reading, generating and displaying are performed so that a time-exposure image capture is generated; and
actuating the controller a second time such that other images are captured.

13. The method of claim 10, further comprising the steps of:
generating an exposure histogram for each one of the non-destructive reads; and
displaying the exposure histogram after the exposure histogram is generated such that the exposure histogram is displayed on the periodic basis.

14. The method of claim 10, further comprising the steps of:
generating a developing exposure image for each one of the non-destructive reads; and
displaying the developing exposure image after the developing exposure image is generated such that the developing exposure image is displayed on the periodic basis.

15. The method of claim 14, further comprising the steps of:
non-destructively reading selected ones of the plurality of photosensitive sites;
generating a developing thumbnail image for each one of the non-destructive reads; and
displaying the developing thumbnail images after generation, such that the developing thumbnail images are displayed on the periodic basis.

16. The method of claim 14, further comprising the steps of:
non-destructively reading selected ones of the plurality of photosensitive sites;
generating a developing low-resolution exposure image for each one of the non-destructive reads; and
displaying the developing low-resolution images after generation, such that the developing low-resolution exposure images are displayed on the periodic basis.

17. The method of claim 14, wherein the steps of generating and displaying the developing exposure image further comprises generating and displaying full-sized high-resolution exposure images.

18. The method of claim 10, further comprising the steps of:
generating an exposure histogram and a corresponding developing exposure image for each one of the non-destructive reads; and
displaying the exposure histograms and the corresponding developing exposure images after generation such that the exposure histograms and the corresponding developing exposure images are displayed on the periodic basis.

19. The method of claim 10, further comprising the steps of:
generating a preview image;
generating an exposure histogram for each one of the non-destructive reads; and
displaying the exposure histograms with the preview image after generation such that the exposure histogram and the preview image are displayed on the periodic basis.

20. A system for indicating exposure information during image capture, comprising:
means for selecting ones of a plurality of photosensitive sites residing in a photosensor;
means for non-destructively reading on a periodic basis the selected photosensitive sites;
means for generating an exposure information for each one of the non-destructive readings; and
means for displaying the exposure information after the exposure information is generated, such that the exposure information is displayed on the periodic basis.

21. The system of claim 20, further comprising means to activate the system when time-exposure images are captured and to deactivate the system when other images are captured.

22. The system of claim 20, further comprising:
means for initiating image capture wherein an image capture exposure period is started; and
means for terminating image capture wherein the image capture exposure period is ended.

23. The system of claim 20, further comprising:
means for generating an exposure histogram and a corresponding developing exposure image for each one of the non-destructive reads; and
means for displaying the exposure histograms and the corresponding developing exposure images after generation such that the exposure histograms and the corresponding developing exposure images are displayed on the periodic basis.

24. The system of claim 20, further comprising:
means for generating a preview image;
means for generating an exposure histogram for each one of the non-destructive reads; and
means for displaying the exposure histograms with the preview image after generation such that the exposure histogram and the preview image are displayed on the periodic basis.

25. A computer-readable medium having a program for indicating exposure information during image capture, the program comprising logic configured to perform the steps of:
non-destructively reading a plurality of photosensitive sites residing in a photosensor on a periodic basis;
generating an exposure information for each one of the non-destructive reads; and
communicating the exposure information to a display after the exposure information is generated, such that the exposure information is displayed on the periodic basis.

26. The computer-readable medium of claim 25, further comprising logic configured to perform the steps of:
generating an exposure histogram and a corresponding developing exposure image for each one of the non-destructive reads; and
communicating the exposure histograms and the corresponding developing exposure images to the display after generation such that the exposure histograms and the corresponding developing exposure images are displayed on the periodic basis.

27. The computer-readable medium of claim 25, further comprising logic configured to perform the steps of:
generating a preview image;
generating an exposure histogram for each one of the non-destructive reads; and
displaying the exposure histograms with the preview image after generation such that the exposure histogram and the preview image are displayed on the periodic basis.

28. The computer-readable medium of claim 25, further comprising logic configured to perform the steps of:
generating an exposure histogram for each one of the non-destructive reads; and
communicating the exposure histograms to the display after generation such that the exposure histograms are displayed on the periodic basis.
